(19) United States
(12) Patent Application Publication
(10) Pub. No.: US 2011/0281058 A1
(43) Pub. Date: Nov. 17, 2011

(54) NET TABLE AND INDIVIDUAL NET DISH COVERS

(76) Inventor: Betty K. Stanford, Plainview, TX (US)

(21) Appl. No.: 13/052,071

(22) Filed: Mar. 19, 2011

Related U.S. Application Data
(60) Provisional application No. 61/334,634, filed on May 14, 2010.

(51) Int. Cl. B32B 3/06

(52) U.S. Cl. 428/99

(57) ABSTRACT

The invention relates to a novel table and dish cover design. The novel net table and individual dish covers enables individuals to protect a table of food from insects and debris until the food is served. The invention can be used to cover an entire table or individual dishes. The netting prevents bugs and other foreign objects from landing on the food and contaminating it. This invention is ideal when serving food outdoors, such as at a picnic at the park, a barbeque, or on the deck. Individuals will appreciate the protection and cleanliness this product provides.

### CROSS-REFERENCE TO RELATED APPLICATIONS

This application claims the benefit under Title 35 United States Code §119(e) of U.S. Provisional Patent Application Ser. No. 61/334,634; Filed: May 14, 2010, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention relates to table and dish covers. More specifically, the present invention relates to table and dish covers consisting of a fabric covering made from a translucent material, such as a mesh and by extension the covering may be extended to various sizes and shapes to cover variations in table and dish designs.

### BACKGROUND OF THE INVENTION

Without limiting the scope of the disclosed invention, the background is described in connection with a novel table and dish cover. Many times when serving a meal, the food is set out on the table before the guests are ready to eat. When setting up a meal outside, it can be difficult to keep the insects and flies off of the food. There are many occasions where food is served outside, such as at a picnic or while out on the deck. It can be extremely frustrating trying to protect the food from contaminants. A more efficient method is needed. Thus the present invention proposes a novel table and dish cover.

### BRIEF SUMMARY OF THE INVENTION

The present invention, therefore, provides a novel table and dish cover. This is the first effective and efficient cover for tables and dishes. Current table and dish cover strategies have had only limited success. Thus, there remains a critical need for the development of alternate approaches to table and dish covers that are applicable to various designs and that are reusable.

Net table and individual dish covers enables consumers to protect a table of food from insects and debris until the food is served. The product can be used to cover an entire table or individual dishes. The netting prevents bugs and other foreign objects from landing on the food and contaminating it. This invention is ideal when serving food outdoors, such as at a picnic at the park, a barbeque, or on the deck. Consumers will appreciate the protection and cleanliness this product provides.

In summary, the present invention discloses a novel table and dish cover which provides protection from contaminants.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a depiction of the net cover design as applied to cover an entire table in accordance with embodiments of the disclosure;

FIG. 2 is a depiction of the net cover design highlighting the lace border and drawstring in accordance with embodiments of the disclosure;

FIG. 3 is a depiction of the net cover design as applied to cover a dish in accordance with embodiments of the disclosure;

FIG. 4 is a depiction of the net cover design being removed for serving as applied to cover an entire dish in accordance with embodiments of the disclosure;

FIG. 5 is a depiction of the net cover design as applied to cover a table with an umbrella in accordance with embodiments of the disclosure.

### DETAILED DESCRIPTION OF THE INVENTION

Disclosed herein is a table and dish cover. The numerous innovative teachings of the present invention will be described with particular reference to several embodiments (by way of example, and not of limitation).

Net table and individual net dish covers offers an effective method for protecting food from insects when serving food outdoors. The invention consists of a fabric covering made from a translucent material, such as mesh. The fabric may be trimmed in lace or other decorative fabric. It may be available in a variety of sizes, shapes, and designs to accommodate different tables or dishes. The cover may be available in small, individual sizes to cover plates, bowls, and the like and also available in a larger variation to cover an entire table. The material should be lightweight and washable. It can be folded for easy storage. A drawstring may be sewn into the perimeter of the cover so that it can be pulled tightly over the table or dish. This will prevent the wind from blowing it off. Small weights may also be utilized for this purpose. The exact specifications may vary.

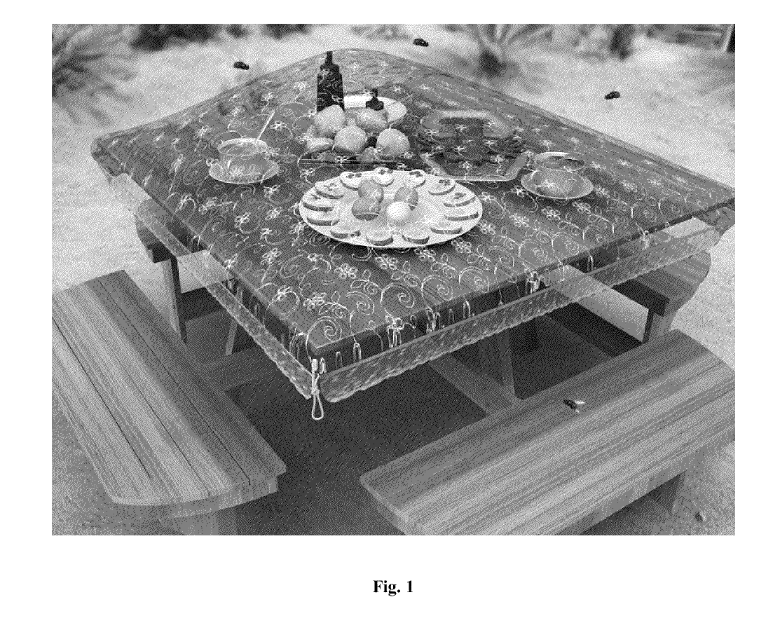

The net cover in accordance with the present disclosure is shown in FIG. 1 and represents the net table cover embodiment shown over a table protecting the food.

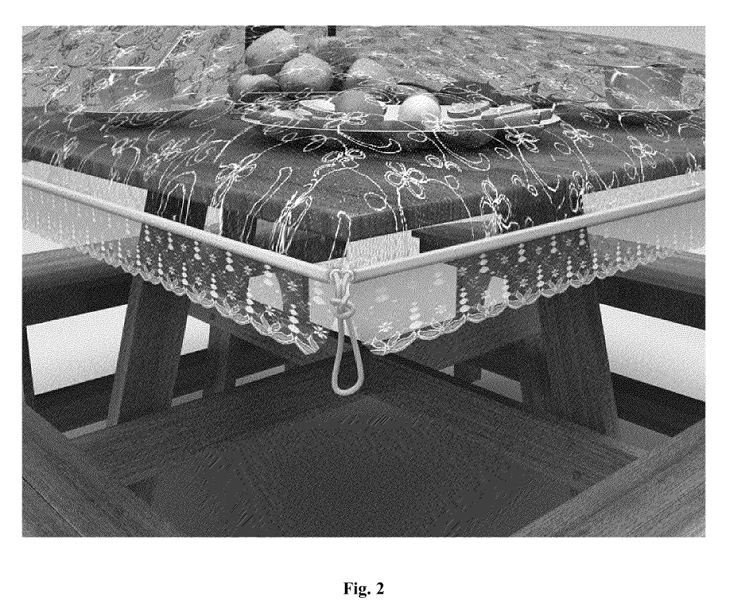

Reference will now be made to FIG. 2 in which the net table cover design is shown highlighting the lace border and drawstring in accordance with the present disclosure. In one embodiment a draw string is fastened one inch above the end of the material around the perimeter of the net table cover. A one inch length is ideal since this provides additional support over fastening the draw string in a hem along the perimeter. In addition, the one inch material below the draw string may be used in a decorative fashion to enhance the products appeal. In another embodiment, weights may be attached in various fashions along the perimeter to maintain the table net cover in desired positions over the covered table. In yet another embodiment, an elastic band is attached throughout the perimeter of the net table cover as a means of fastening.

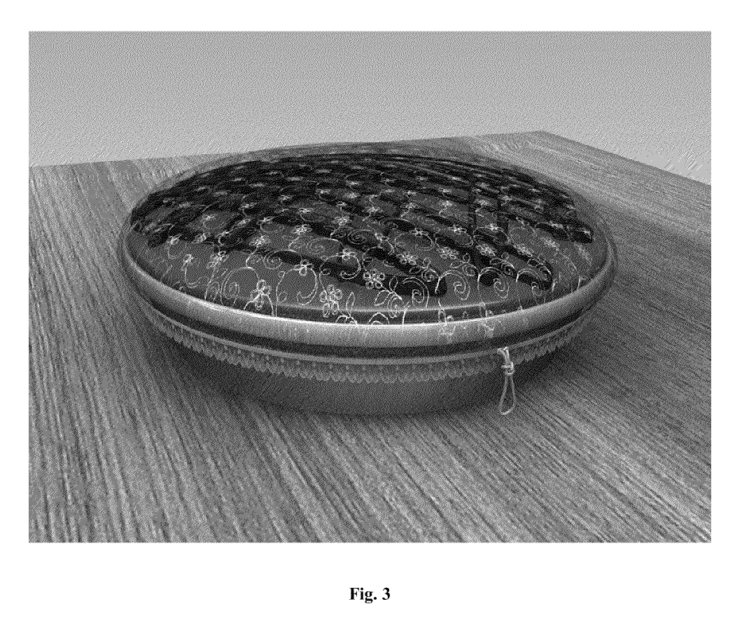

Reference will now be made to FIG. 3 in which the net cover design is applied to cover a dish in accordance with the present disclosure. In one embodiment, the material is made of a translucent material. This enables easy visual identification of the contents being covered. Along with the net table cover, the net dish cover may use various means for fastening such as the drawstring, weights, and elastic band approach as mentioned above.

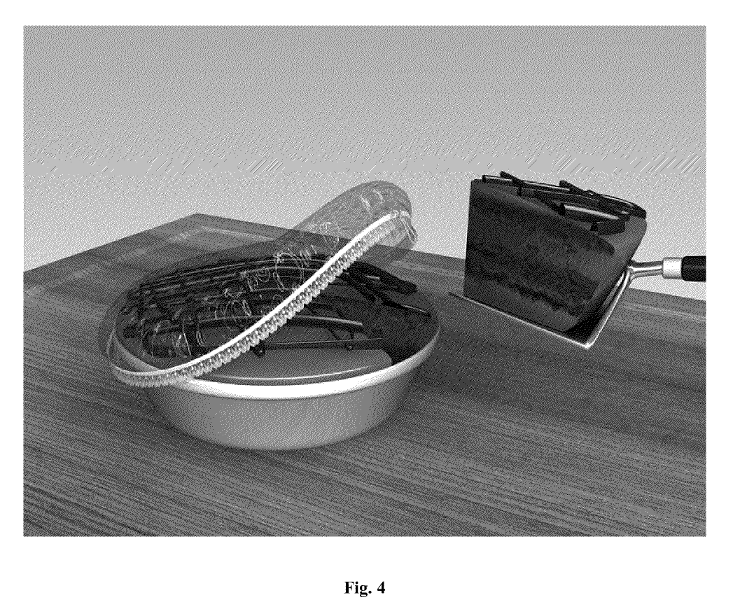

Reference will now be made to FIG. 4 which shows the net cover design being removed for serving as applied to cover an entire dish in accordance with the present disclosure.

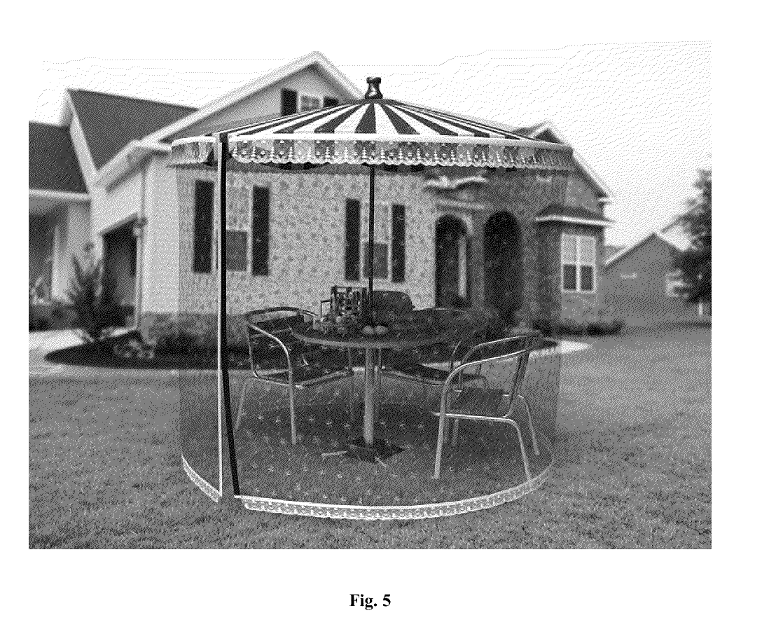

Lastly, reference is made to FIG. 5 which depicts an embodiment for implementing the invention to cover a table with an umbrella.

The disclosed net table and individual net dish covers is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a,” “an,” and “the” are not intended to refer to only a singular entity, but include the general class of which a specific example may be used for illustration. The terminology herein is used to describe specific embodiments of the invention, but their usage does not delimit the disclosed method, except as may be outlined in the claims.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific features of the invention described herein. Such equivalents are considered to be within the scope of this invention and are covered by the claims.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of” respectively, shall be closed or semi-closed transitional phrases.

All of the net tables and individual net dish covers disclosed and claimed herein can be made and executed without undue experimentation in light of the present disclosure. While the invention has been described in terms of preferred embodiments, it will be apparent to those skilled in the art that variations may be applied to the invention described herein without departing from the concept, spirit, and scope of the invention.

More specifically, it will be apparent that certain components which are both related by material and function may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A table cover comprising: fabric or material in a sufficient amount to cover the top of the table; said fabric or material is configured to fit in shape and size for the table; and a means for attaching to said table located at least an inch from the end of the fabric or material along the perimeter.

2. The table cover as in claim 1, wherein said means for attaching comprises a drawstring.

3. The table cover as in claim 1, wherein said means for attaching comprises weights.

4. The table cover as in claim 1, wherein said means for attaching comprises an elastic band.

5. The table cover as in claim 1, wherein the fabric or material is translucent.

6. The table cover as in claim 2, wherein the fabric or material is translucent.

7. The table cover as in claim 3, wherein the fabric or material is translucent.

8. The table cover as in claim 4, wherein the fabric or material is translucent.

9. A dish cover comprising: fabric or material in a sufficient amount to cover the dish; said fabric or material is configured to fit in shape and size for the dish; and a means for attaching to said dish located at least an inch from the end of the fabric or material along the perimeter.

10. The dish cover as in claim 9, wherein said means for attaching comprises a drawstring.

11. The dish cover as in claim 9, wherein said means for attaching comprises weights.

12. The dish cover as in claim 9, wherein said means for attaching comprises an elastic band.

13. The dish cover as in claim 9, wherein the fabric or material is translucent.

14. The dish cover as in claim 10, wherein the fabric or material is translucent.

15. The dish cover as in claim 11, wherein the fabric or material is translucent.

16. The dish cover as in claim 12, wherein the fabric or material is translucent.
